(19) United States
(12) Patent Application Publication
(10) Pub. No.: US 2005/0224046 A1
(43) Pub. Date: Oct. 13, 2005

(54) Apparatus and method for retarding an engine with an exhaust brake and a compression release brake

(75) Inventors: Mark A. Israel, Amherst, MA (US); John P. Hartley, Blaine, WA (US); Vincent A. Meneely, Langley, CA (US)

Correspondence Address: BERENATO, WHITE & STAVISH, LLC, 6550 ROCK SPRING DRIVE, SUITE 240, BETHESDA, MD, 20817, US

(73) Assignee: JENARA ENTERPRISES LTD., Surrey (CA)

(21) Appl. No.: 10/506,662

(22) PCT Filed: Mar. 4, 2003
(86) PCT No.: PCT/CA03/00305

§ 371 Date: May 2, 2005

Related U.S. Application Data
(60) Provisional application No. 60/361,280, filed on Mar. 4, 2002.

(51) Int. Cl. F02D 13/04

(52) U.S. Cl. 123/321

(57) ABSTRACT

An apparatus and method for retarding an engine having a cylinder with an exhaust valve, an intake valve, an intake stroke, an exhaust stroke, a compression stroke and an expansion stroke. The apparatus includes an exhaust brake and a compression release brake. The exhaust brake includes a variable exhaust restrictor, a pressure sensor for sensing pressure of exhaust gases and a controller operatively connected to the pressure sensor and to the exhaust restrictor. Opening of the exhaust restrictor is adjusted during operation of the apparatus so exhaust pressure is sufficient to cause exhaust valve float prior to bottom dead center of intake strokes of the cylinder, thereby enhancing operation of the compression release brake.

### BACKGROUND OF THE INVENTION

This invention relates to methods and apparatuses for retarding engines and, in particular, to compression release brakes, such as bleeder brakes, and to exhaust brakes.

Conventional compression release brakes retard engines by opening the exhaust valves just prior to Top Dead Center (TDC) of the compression stroke. This creates a blow-down of the compressed cylinder gas and the energy used for compression is not reclaimed. The result is engine braling, or retarding, power. This type of brake has substantial cost associated with the hardware required to open the exhaust valves against the extremely high load of the compressed cylinder charge. The valve train components must be designed and manufactured to operate reliably at high mechanical loading. Also, the sudden release of the highly compressed gas causes high noise levels. This means that engine brakes cannot be used in certain areas, typically urban areas, leading to a potential safety hazard.

The power generated by an engine brake is directly proportional to the mass of air that is charged into the cylinder before compression. On a conventional system, the turbocharger compressor provides this air. It is beneficial, therefore, to keep the turbocharger speed as high as possible to maximize cylinder charge. Braking power may fall off sharply at reduced engine speeds, when the turbocharger slows down and delivers less air to the cylinder.

Exhaust brakes can be used on engines where compression release loading is too great for the valve train. The exhaust brake mechanism conventionally consists of a restrictor element mounted in the exhaust system. When this restrictor is closed, back pressure resists the exit of gases during the exhaust cycle and provides a braking function. The system provides less braking power than a compression release brake, but is also less costly. As with a compression release brake, the retarding power of an exhaust brake falls off sharply as engine speed decreases. This happens because the restriction is normally optimized to generate maximum allowable back pressure at rated engine speed. The restriction is simply insufficient to be effective at lower engine speeds.

U.S. Pat. No. 5,086,738 to Meneely discloses a system to enhance engine braking power by combining an exhaust brake with a compression release brake. With both brakes on, a high-pressure pulse from an adjacent cylinder in the same exhaust manifold superimposes on the raised average exhaust pressure. Enough force is generated to temporarily open the exhaust valves against the exhaust valve spring preload. This opening by overcoming the valve springs is referred to as “valve float”. This occurs naturally around the end of the intake stroke. The high-pressure gas in the exhaust manifold supercharges the cylinder through the open exhaust valve just before the brake event. Compression begins at a higher cylinder pressure and is compressed to a higher peak value for the blow-down. In addition, an exhaust brake component is provided by virtue of the high exhaust pressure with the operation of the exhaust brake. This approach is mainly effective only at high engine speeds as the conditions for valve float diminish quickly as engine speed decreases.

U.S. Pat. No. 6,170,474 to Israel discloses a method for exhaust pressure regulation by controlling an internal exhaust gas recirculation process. The control is carried out responsive to monitored levels of exhaust pressure and/or temperature. A restriction is provided in the exhaust system to raise exhaust pressure. A reopening of the engine exhaust valves is introduced to provide a passage for exhaust gas to re-enter the cylinder from the exhaust manifold. This simultaneously relieves exhaust system pressure and supercharges the cylinder for engine braking. By controlling the timing and magnitude of this event, exhaust pressure is regulated.

Retarding power on the order of the rated power of the engine can be achieved by combining a bleeder brake with an exhaust brake. U.S. Pat. No. 5,215,054 to Meneely incorporates a catch mechanism that holds the exhaust valve open at the end of the exhaust stroke, at the level required to bleed the cylinder during the compression stroke.

Further gains in retarding power can be attained with a combination of a bleeder-exhaust brake by raising the exhaust pressure to where natural valve float occurs. U.S. Pat. No. 5,787,858 to Meneely uses this technique to supercharge the cylinder prior to the compression stroke. The valve is reseated near the end of the compression stroke by means of electronic triggering of a solenoid valve.

A Microprocessor Controlled Exhaust Brake is disclosed in PCT Publication No. WO 02/086300 to Anderson et al. Here the opening of the exhaust brake is regulated according to the exhaust pressure and, in some embodiments, according to the exhaust temperature. A controller, acting through a solenoid, adjusts the exhaust brake, typically a butterfly valve.

Despite these earlier devices, however, there still remains a significant need for a low-cost engine braking system that can be integrated into an overall engine design. A practical system should provide sufficient retarding power without overloading the mechanical and thermal components of the engine. It should provide mass charging to the cylinders from the intake and exhaust subsystems prior to the compression and release events that is sufficient to generate optimum retarding power at all engine speeds. It should also provide quiet operation so as to be useful in environments sensitive to noise pollution. Therefore, a means of regulating exhaust pressure must also be provided.

### SUMMARY OF THE INVENTION

According to one aspect of the invention, an apparatus for retarding an engine has a cylinder with an exhaust valve, an intake valve, an intake stroke, an exhaust stroke, a compression stroke and an expansion stroke. The apparatus includes an exhaust brake and a compression release brake. The exhaust brake includes a variable exhaust restrictor, a pressure sensor for sensing pressure of exhaust gases, a controller operatively connected to the pressure sensor and to the exhaust restrictor so as to adjust opening of the exhaust restrictor during operation of the apparatus so exhaust pressure is sufficient to cause exhaust valve float prior to bottom dead center of intake strokes of the cylinder, thereby enhancing operation of the compression release brake.

According to another aspect of the invention, there is a method for retarding an engine apparatus having a cylinder with an exhaust valve, an intake valve, an intake stroke, an exhaust stroke, a compression stroke and an expansion stroke. The apparatus includes an exhaust brake and a compression release brake. The exhaust brake includes a variable exhaust restrictor, a pressure sensor for sensing pressure of exhaust gases, a controller operatively connected to the pressure sensor and to the exhaust restrictor. The controller adjusts opening of the exhaust restrictor during operation of the apparatus so exhaust pressure is sufficient to cause exhaust valve float prior to bottom dead center of intake strokes of the cylinder, thereby enhancing operation of the compression release brake.

The invention offers significant advantages over the prior art. Compared to a conventional compression release brake, it does not require the expensive hardware required to open exhaust valves against the extremely high load of the compressed cylinder charge. However, at low engine speeds engine braking is enhanced because the exhaust restrictor is closed a sufficient amount to maintain a pressure which causes exhaust valve float, and thereby enhances operation of the bleeder brake at low engine speeds as well.

Moreover the invention provides a low-cost engine braking system which can be integrated into overall engine design. Mechanical and thermal components of the engine are not overloaded since the exhaust restrictor can be adjusted below maximum temperature and pressure limits.

Finally, by regulating exhaust pressure, the system ensures relatively quiet brake operation compared with conventional compression release brakes. Thus engine braking systems according to the invention may be utilized in environment sensitive to noise pollution, such as urban areas.

### BRIEF DESCRIPTION OF THE DRAWINGS

In the drawings:

FIG. 1 is a diagrammatic view of an internal combustion engine equipped with an engine retarding system according to an embodiment of the invention;

FIG. 2 is a sectional view of the hydraulically extensible member thereof;

FIG. 3 is a sectional view of the rocker arm, adjustment screw and hydraulically extensible member;

FIG. 4 is a valve lift profile diagram of the engine of FIG. 1 equipped with the engine retarding system in the retarding mode; and

FIG. 5 is a Pressure-Volume diagram thereof showing the retarding power components of the engine retarding system.

### DETAILED DESCRIPTIONS OF THE PREFERRED EMBODIMENTS

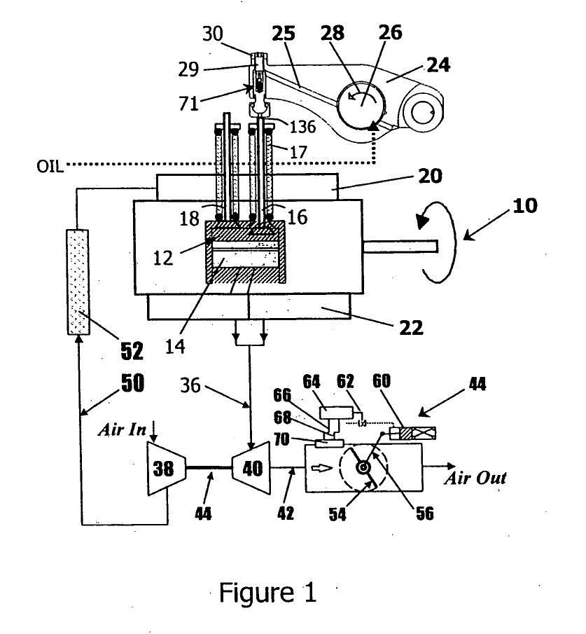

Referring to the drawings and first to FIG. 1, this shows an internal combustion engine 10, a diesel engine in this instance, equipped with a plurality of cylinders, only cylinder 12 being shown for simplicity. Each cylinder is provided with a piston 14 which reciprocates therein. Each cylinder has an exhaust valve 16 and an intake valve 18. Each cylinder may have more than one intake valve and/or exhaust valve, but again only one of each is shown for simplicity. The engine also has an intake manifold 20 and an exhaust manifold 22.

In the conventional manner exhaust valve 16 is opened by rotation of rocker arm 24 about rocker arm shaft 26 in the direction indicated by arrow 28. The rocker arm is provided with an adjustment screw 29 capable of adjusting clearance between the rocker arm and the valve.

The exhaust manifold 22 is connected to a turbocharger 34 by an exhaust conduit 36. The turbocharger includes a compressor 38 and a turbine 40. The exhaust gases exit the turbine through conduit 42, which comprises exhaust brake 44. Air compressed by the compressor 38 is carried by a conduit 50 to the intake manifold 20 through charge cooler 52. In this example of the invention the exhaust brake is a Microprocessor Controlled Exhaust Brake as disclosed in PCT Publication No. WO 02/086300 to Anderson et al., which is incorporated herein by reference, although other variable exhaust restrictions could be substituted. For example, a highly restrictive turbocharger may be employed. This may be a variable wastegate or a variable geometry type. Alternatively the restriction may be placed before or after the turbine. Where the restriction is installed upstream of the turbine, advantage is taken by generating a high-pressure differential across it.

In this example the exhaust restrictor is in the form of a butterfly valve 54 in the exhaust conduit 42. The butterfly is rotated by linkage 56 connected to an actuator 60, a pneumatic actuator in this particular example, although other actuating devices could be substituted. The actuator is actuated by a solenoid valve 62 which communicates with a controller 64. The controller receives pressure and temperature signals 66 and 68 from sensors 70.

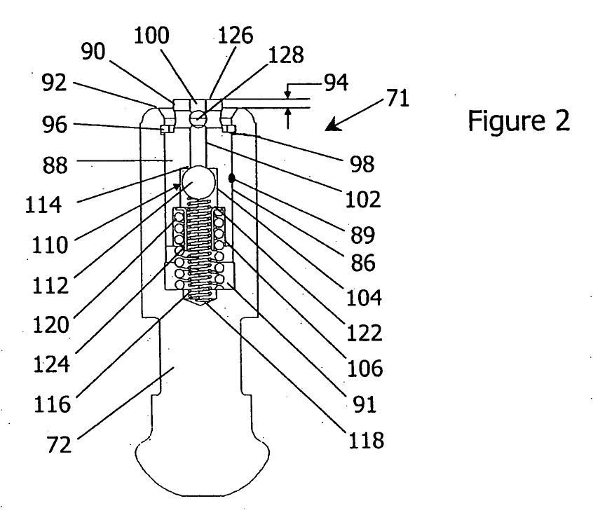

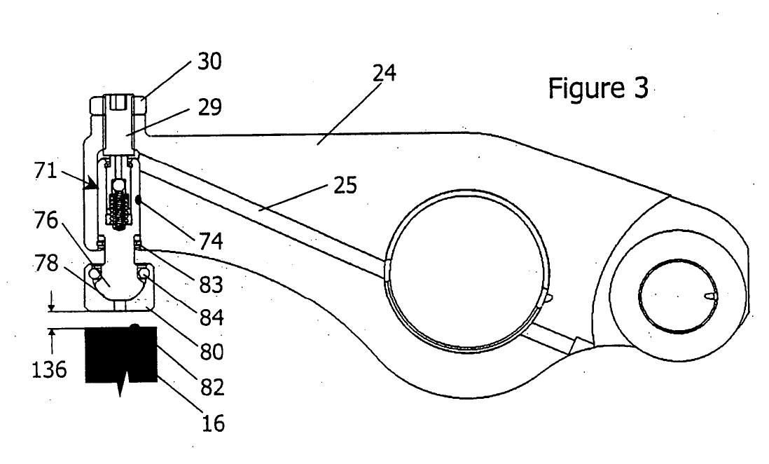

Referring to FIGS. 2 and 3, the rocker arm 24 has a hydraulic extension member 71 including a lifter body 72 reciprocatingly mounted within a cylindrical bore 74 and held in by a retainer ring 83. The lifter body has a ball-like end 76 received in socket 78 of exhaust valve interface member 80 which contacts top 82 of the exhaust valve 16. There is a retaining ring 84 which holds the ball and socket assembly together.

The lifter body has an internal bore 86 which reciprocatingly receives a plunger 88. Radial clearance 89 is provided between the plunger and the bore. The plunger has a protrusion 90 which extends above the top 92 of the lifter body by an amount 94 when the plunger is in its uppermost position has shown in FIG. 2. There is a retaining ring 96 within the bore which contacts shoulder 98 of the plunger to limit upward movement of the plunger from the point of view of FIG. 2. However protrusion 90 is sized to fit through the retaining ring. A hydraulic chamber 91 is located within the bore 86 below the plunger.

There is an internal passageway 100 extending longitudinally through the plunger including a relatively narrow hydraulic conduit 102 adjacent to the top of the plunger, a wider portion 104 below portion 102 and a still wider portion 106 below portion 104. A check valve 110 is located within portions 104 and 106 including a ball 112 within the portion 104. A valve seat 114 for the check valve is formed between the portions 102 and 104. The ball of the check valve is biased upwardly by a coil spring 116 having its bottom within a recess 118 at the bottom of bore 86.

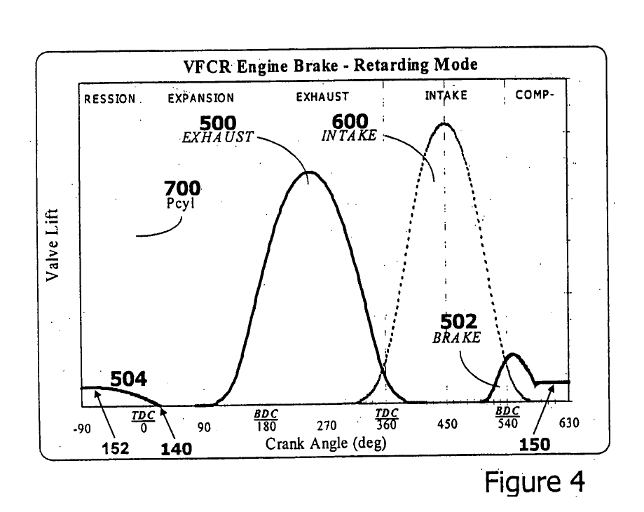

Another coil spring 120 is fitted between shoulder 122, where portions 104 and 106 of passageway 100 meet, and the bottom of the bore. This spring biases the plunger upwardly from the point of view of FIG. 4. There is a collar 124 fitted between the springs 116 and 118 within the plunger and which contacts the shoulder 122.

As may be seen, the hydraulic conduit 102 extends through the top 126 of the plunger. A second hydraulic conduit 128 extends through the plunger and intersects the conduit 102 below the top.

During normal engine operation underpower, the exhaust restrictor 54 of exhaust brake 44 shown in FIG. 1 remains open. However, when the throttle is closed, and engine retarding or braking is desired, the restrictor is closed sufficiently by controller 64, acting through solenoid 62 and actuator 60, to cause valve float of the exhaust valve 16 near the end of the intake stroke for cylinder 12. This valve float is illustrated at 502 in FIG. 4. The degree by which the restrictor is closed is determined by the processor to give sufficient pressure to cause the exhaust valve float. However this is done within designated exhaust pressure and exhaust temperature limits as sensed by sensors 70 to avoid excess strain or damage to the engine. The controller includes a lookup table of exhaust pressure values which are sufficient to cause valve float of the exhaust valves, but are below maximum pressure values.

The amount of exhaust valve gap or lash 136, shown in FIGS. 1 and 3, increases when the valve floats. The amount 94 of the plunger 88 extending above the top 92 of the lifter body 72, as shown in FIG. 2, is greater than the exhaust valve lash. When the valve floats, the plunger 88 moves upwardly, from the point of view of FIG. 2, to its uppermost position and hydraulic fluid, in this example engine oil, enters through hydraulic conduit 102 and fills the chamber 91. When the exhaust valve attempts to close after floating, it is held opened by the interface member 80 on the bottom of lifter body 72 which has been extended downwardly to close gap 136 by the upward movement of plunger 88 contacting adjustment screw 29.

The radial clearance 89 between the plunger and the bore 86 permits hydraulic fluid to gradually leak out of chamber 91 with continued upward pressure of the exhaust valve. This permits the exhaust valve in this example to effectively close just after the end of the compression stroke as seen at 140 in FIG. 4. The valve may close from the bleeder lift prior to the normal exhaust stroke, or the excess lift may bleed out of chamber 91 during opening of the normal exhaust event. The critical thing is that the exhaust valve be closed or nearly closed at the end of the exhaust stroke. The valve may remain open some small amount in the order of 0.005″-0.010″.

As seen in FIG. 4, the main exhaust event 500 and the main intake event 600 occur at their normal times. When the pressure is raised sufficiently in the exhaust manifold by closing the restrictor 54, the force on the back of the exhaust valve 16 overcomes the resisting force of the valve spring 17 seen in FIG. 1. Exhaust gases are then forced into the cylinder 12. This charges cylinder 12 prior to the compression stroke. As the exhaust valve 16 moves away from the valve train, the gap 136 shown in FIG. 3 is taken up by the upward movement of the plunger 88 and consequent downward movement of lifter body 72. This holds the exhaust valve off its seat for the remainder of the compression stroke as seen at 150 and 152 in FIG. 4. As pressure in the cylinder builds, however, the exhaust valve moves back to its reseated position due to the leakage of hydraulic fluid past radial clearance 89 as well as due to compression of the hydraulic fluid within chamber 91. The valve closing by oil compression is recovered as the forces subside, but valve closing by leakage does not recover and lost fluid must be refilled on each engine cycle.

During normal engine operation, under positive power, the restrictor 54 is open and there is no valve float. The hydraulic link comprising lifter body 72 and plunger 88 remains loaded throughout the engine cycle and cannot expand to hold the exhaust valve off its seat. The engine brake is thus disabled.

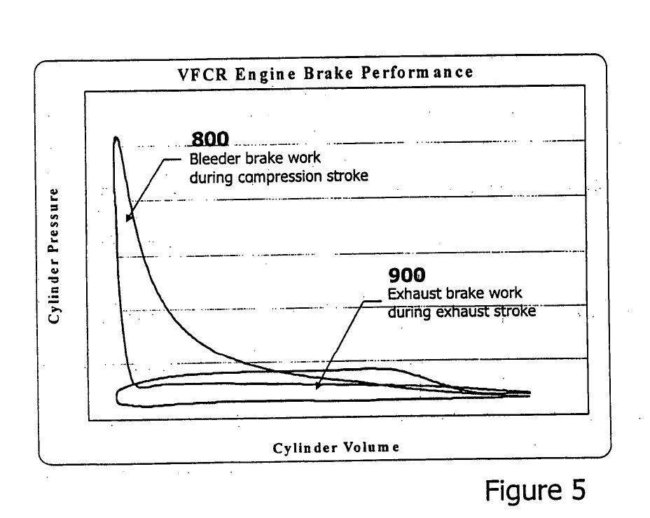

The engine brake has two performance components. The bleeder brake component comprises the holding open of the exhaust valve by the hydraulic link, or extension member 71 comprising lifter body 72 and plunger 88. This works during the compression stroke, the work being illustrated at 800 in FIG. 5. The exhaust brake component, caused by the closing of exhaust restrictor 54, works during the exhaust stroke and is shown at 900 in FIG. 5. The total retarding work is represented by the area bounded by the two loops in the curve of the pressure-volume diagram.

It will be understood by someone skilled in the art than many of the details above are given by way of example only and can be altered or deleted without departing from the scope of the invention as set out in the following claims.

1. An apparatus for retarding an engine having a cylinder with an exhaust valve, an intake valve, an intake stroke, an exhaust stroke, a compression stroke and an expansion stroke, the apparatus including an exhaust brake and a compression release brake, the exhaust brake including a variable exhaust restrictor, a pressure sensor for sensing pressure of exhaust gases, a controller operatively connected to the pressure sensor and to the exhaust restrictor so as to adjust opening of the exhaust restrictor during operation of the apparatus so exhaust pressure is sufficient to cause exhaust valve float prior to bottom dead center of intake strokes of the cylinder, thereby enhancing operation of the compression release brake.

2. The apparatus of claim 1, wherein the compression release brake is a bleeder brake and includes a device for maintaining the exhaust valve open during the compression stroke.

3. The apparatus of claim 2, wherein the engine has a valve opening mechanism for the exhaust valve, said device for maintaining the exhaust valve open including a hydraulic device.

4. The apparatus of claim 3, wherein the valve opening mechanism for the exhaust valve includes a rocker arm, the device for maintaining the exhaust valve open including a hydraulically extendable member mounted on the rocker arm which contacts said exhaust valve.

5. The apparatus of claim 4, wherein the member is reciprocatingly mounted in a cylinder on the rocker arm, a passageway providing hydraulic fluid to the cylinder to extend the member when there is clearance between the member and the valve.

6. The apparatus of claim 5, including a check valve for inhibiting hydraulic fluid flowing from the cylinder to the passageway when the rocker arm moves towards the exhaust valve.

7. The apparatus of claim 6 including means permitting controlled leakage of hydraulic fluid from the cylinder during the compression stroke so as to allow the exhaust valve to effectively close at completion of the exhaust stroke.

8. The apparatus of claim 1, wherein the exhaust restrictor is a butterfly valve.

9. The apparatus of claim 1, wherein the exhaust restrictor is a variably restrictive turbocharger.

10. The apparatus of claim 2, wherein the device maintains the exhaust valve open throughout the compression stroke.

11. The apparatus of claim 1, wherein the controller includes a lookup table of exhaust pressure values which are sufficient to cause said valve float of the exhaust valve, but below a maximum value.

12. The apparatus of claim 1, including a temperature sensor for sensing exhaust gas temperatures, the temperature sensor being operatively connected to the controller, the controller adjusting the exhaust restrictor so the exhaust temperature remains below a maximum value.

13. A method for retarding an engine apparatus having a cylinder with an exhaust valve, an intake valve, an intake stroke, an exhaust stroke, a compression stroke and an expansion stroke, the apparatus including an exhaust brake and a compression release brake, the exhaust brake including a variable exhaust restrictor, a pressure sensor for sensing pressure of exhaust gases and a controller operatively connected to the pressure sensor and to the exhaust restrictor, the method comprising adjusting the opening of the exhaust restrictor during operation of the apparatus, utilizing the controller and exhaust restrictor, so exhaust pressure is sufficient to cause exhaust valve float prior to bottom dead center of intake strokes of the cylinder, thereby enhancing operation of the compression release brake.

14. The method of claim 13, wherein the compression release brake is a bleeder brake and maintains the exhaust valve open during the compression stroke.

15. The method of claim 14, wherein the engine has a valve opening mechanism for the exhaust valve, the exhaust valve being maintained open hydraulically.

16. The method of claim 15, wherein the valve opening mechanism for the exhaust valve includes a rocker arm, the exhaust valve being maintained opened by a hydraulically extendable member mounted on the rocker arm which contacts said exhaust valve.

17. The method of claim 16, wherein the member is reciprocatingly mounted in a cylinder on the rocker arm, hydraulic fluid being provided through a passageway to the cylinder and extending the member when there is clearance between the member and the valve.

18. The method of claim 17, including a check valve which inhibits hydraulic fluid flowing from the cylinder to the passageway when the rocker arm moves towards the exhaust valve.

19. The method of claim 18 including the step of permitting controlled leakage of hydraulic fluid from the cylinder during the compression stroke so as to allow the exhaust valve to effectively close at completion of the exhaust stroke.

20. The method of claim 13, wherein the exhaust is restricted by a butterfly valve.

21. The method of claim 13, wherein the exhaust is restricted by a variably restrictive turbocharger.

22. The method of claim 14, wherein the exhaust valve is kept open throughout the compression stroke.

23. The method of claim 14, wherein the controller utilizes a lookup table of exhaust pressure values which are sufficient to cause said valve float of the exhaust valve, but below a maximum value.

24. The method of claim 13, including a temperature sensor for sensing exhaust gas temperatures, the temperature sensor being operatively connected to the controller, the controller adjusting the exhaust restrictor so the exhaust temperature remains below a maximum value.
